(19) United States
(12) Patent Application Publication
(10) Pub. No.: US 2020/0413007 A1
(43) Pub. Date: Dec. 31, 2020

(54) OPERATOR TERMINAL AND CALIBRATION METHOD

(71) Applicant: PANASONIC INTELLECTUAL PROPERTY MANAGEMENT CO., LTD., Osaka (JP)

(72) Inventors: Kazuyuki HORIO, Tokyo (JP); Issei IKEZAKI, Fukuoka (JP)

(73) Assignee: PANASONIC INTELLECTUAL PROPERTY MANAGEMENT CO., LTD., Osaka (JP)

(21) Appl. No.: 16/975,590

(22) PCT Filed: Feb. 7, 2019
(86) PCT No.: PCT/JP2019/004506

§ 371 Date: Aug. 25, 2020

(30) Foreign Application Priority Data
Feb. 26, 2018 (JP) 2018-032224

(51) Int. Cl. H04N 7/14; H04N 5/247; G06T 7/80; G06K 9/00

(52) U.S. Cl. CPC H04N 7/142; H04N 5/247; H04N 7/147; G06K 9/00355; G06K 9/00369; G06T 7/80

(57) ABSTRACT

A calibration method involves displaying on a monitor a frontal video of an upper body of the operator shot by a front-facing camera, the frontal video including a face of the operator, and a video of hands of the operator shot by a downward-facing camera from above; concurrently with displaying the frontal video and the video of the hands, displaying on the monitor a guidance video image as guidance information providing a guidance on a proper state of the operator's upper body in the frontal video and a guidance video image as guidance information providing a proper state of the operator's hands in the video of the hands; and, based on inputs which the operator provides according to the guidance information, adjusting the frontal video and the video of the hands.

### TECHNICAL FIELD

The present invention relates to an operator terminal for bidirectional communication with a kiosk terminal, the operator terminal being configured for bidirectional transmission of a video of a user who operates the kiosk terminal and a video of an operator who operates the operator terminal to and from the kiosk terminal, and a calibration method used in an operator terminal for adjusting a video of an operator to be displayed on a kiosk terminal.

### BACKGROUND ART

In recent years, bidirectional video communication systems for bidirectional transmission of videos of a plurality of persons remotely located from one another. Meanwhile, kiosk terminals are widely used for providing services such as guidance services (providing various types of information) and teller services at financial institutions, taking the place of human operators. Thus, building up a bidirectional video communication system between such a kiosk terminal and an operator terminal operated by an operator enables the operator to provide a face-to-face response to a user, which improves quality of services provided by the kiosk terminal.

In such bidirectional video communication systems, a calibration operation is desirably performed for calibrating video images in order to show an operator in a video displayed on a kiosk terminal in a proper state so that a user can experience a realistic sensation that the user faces the operator over a counter. Known such calibration technologies for calibrating video images include a bidirectional video communication system in which the heights of cameras can be controlled so as to adjust the eye heights of two users interacting with each other over the system to the same level (Patent Document 1).

### PRIOR ART DOCUMENT (S)

### Patent Document(s)

Patent Document 1: JP2003-204531A

### SUMMARY OF THE INVENTION

### Task to be Accomplished by the Invention

In a bidirectional video communication system, in order to enable a user of to experience a realistic sensation that the user sees another user face-to-face, it has been necessary to adjust the eye heights of the two users interacting with each other over the system to the same level as in the above-described prior art, and further necessary to optimize video images so that persons in the video images are displayed in a proper state by, for example, adjusting the size of persons in the video images. In particular, since, in facilities such as a call center, two or more operators alternately use an operator terminal, when operators are changed, it is desirable to enable a calibration operation to be performed in an efficient manner in order to optimize video images so that the new operator can quickly start operations.

However, the problem is that the above-described prior art does not take into account any other type of calibration than adjusting the eye heights of two interacting users to the same level, and thus does not enable a calibration operation to be performed in an efficient manner by optimizing video images such that persons in the video images are displayed in a proper state.

The present invention has been made in view of such problems of the prior art, and a primary object of the present invention is to provide an operator terminal and a calibration method used therein which, upon a change in operators, support a new operator's work associated with a calibration operation for calibrating video images so as to show a new operator in a proper state in a video displayed on a kiosk terminal, thereby allowing efficient calibration operation.

### Means to Accomplish the Task

An aspect of the present invention provides an operator terminal for bidirectional communication with a kiosk terminal, the operator terminal being configured for bidirectional transmission of a video of a user who operates the kiosk terminal and a video of an operator who operates the operator terminal to and from the kiosk terminal, the operator terminal comprising: a communication device configured to perform communication with the kiosk terminal; a front-facing camera configured to shoot a frontal video of an upper body of the operator, the frontal video including a face of the operator; a downward-facing camera configured to shoot hands of the operator from above; a controller configured to transmit the frontal video shot by the front-facing camera and the video of the hands shot by the downward-facing camera to the kiosk terminal, causing the kiosk terminal to display the videos on a front-facing monitor and an upward-facing monitor; and a monitor configured to display a status of a calibration operation for adjusting the frontal video and the video of the hands, wherein the controller is configured such that the controller displays guidance information on the monitor, the guidance information providing a guidance on a proper state of the operator's upper body in the frontal video and a proper state of the operator's hands in the video of the hands, and that, based on inputs which the operator provides according to the guidance information, the controller adjusts the frontal video and the video of the hands.

Another aspect of the present invention provides a calibration method used in an operator terminal for bidirectional communication with a kiosk terminal, the operation terminal being configured for bidirectional transmission of a video of a user who operates the kiosk terminal and a video of an operator who operates the operator terminal to and from the kiosk terminal, the calibration method being configured for adjusting the video of the operator who operates the operator terminal displayed on the kiosk terminal, the method comprising: displaying on a monitor a frontal video of an upper body of the operator acquired by a front-facing camera and a video of hands of the operator acquired by a downward-facing camera, wherein the front-facing camera is configured to shoot the frontal video of the upper body of the operator, the frontal video including a face of the operator, and the downward-facing camera is configured to shoot the hands of the operator from above; concurrently with displaying the frontal video and the video of the hands, displaying guidance information on the monitor, the guidance information providing a guidance on a proper state of the operator's upper body in the frontal video and a proper state of the operator's hands in the video of the hands; and, based on inputs which the operator provides according to the guidance information, adjusting the frontal video and the video of the hands.

### Effect of the Invention

The present invention enables an operator to perform an adjustment operation according to guidance information to thereby acquire a frontal video of an upper body of the operator in a proper state and a video of hands of the operator in a proper state. This allows for efficient calibration operation.

### BRIEF DESCRIPTION OF THE DRAWINGS

FIG. 1 is a diagram showing a general configuration of a bidirectional video communication system according to an embodiment of the present invention;

FIG. 2 is a perspective view showing a kiosk terminal 1;

FIG. 3 is a perspective view showing an operator terminal 2;

FIG. 4 is a block diagram showing schematic configurations of the kiosk terminal 1 and the operator terminal 2;

FIG. 5 is an explanatory diagram showing screens displayed on the kiosk terminal 1;

FIG. 6 is an explanatory diagram showing screens displayed on the operator terminal 2;

FIG. 7 is an explanatory diagram showing a screen for calibration operation in an initial state;

FIG. 8 is an explanatory diagram showing a screen for calibration operation in a confirmation state;

FIG. 9 is an explanatory diagram showing records registered in a settings information database managed by the operator terminal 2; and

FIG. 10 is a flow chart showing a operation procedure of a calibration operation performed by the operator terminal 2.

### DESCRIPTION OF THE PREFERRED EMBODIMENT(S)

A first aspect of the present invention made to achieve the above-described object is an operator terminal for bidirectional communication with a kiosk terminal, the operator terminal being configured for bidirectional transmission of a video of a user who operates the kiosk terminal and a video of an operator who operates the operator terminal to and from the kiosk terminal, the operator terminal comprising: a communication device configured to perform communication with the kiosk terminal; a front-facing camera configured to shoot a frontal video of an upper body of the operator, the frontal video including a face of the operator; a downward-facing camera configured to shoot hands of the operator from above; a controller configured to transmit the frontal video shot by the front-facing camera and the video of the hands shot by the downward-facing camera to the kiosk terminal, causing the kiosk terminal to display the videos on a front-facing monitor and an upward-facing monitor; and a monitor configured to display a status of a calibration operation for adjusting the frontal video and the video of the hands, wherein the controller is configured such that the controller displays guidance information on the monitor, the guidance information providing a guidance on a proper state of the operator's upper body in the frontal video and a proper state of the operator's hands in the video of the hands, and that, based on inputs which the operator provides according to the guidance information, the controller adjusts the frontal video and the video of the hands.

This configuration enables an operator to perform an adjustment operation according to guidance information to thereby acquire a frontal video of an upper body of the operator in a proper state and a video of hands of the operator in a proper state. This allows for efficient calibration operation.

A second aspect of the present invention is the operator terminal of the first aspect, wherein the controller is configured such that the controller displays, as the guidance information, a guidance image indicating the proper state of the operator's upper body in the frontal video and a guidance image indicating the proper state of the operator's upper body in the frontal video.

In this configuration, since the operator can use the guidance image as a reference in adjusting the state of the operator's upper body in the frontal video and the state of the operator's hands in the video of the hands, the operator can perform the adjustment operation in an efficient manner.

A third aspect of the present invention is the operator terminal of the first or second aspect, wherein the controller is configured to display virtual video images on the monitor, the virtual video images indicating how the frontal video and the video of the hands are displayed on the kiosk terminal, respectively.

This configuration enables the operator to determine whether or not the operator's upper body in the frontal video and the operator's hands in the video of the hands can be displayed in a proper balance when the videos are actually displayed on the kiosk terminal.

A fourth aspect of the present invention is the operator terminal of any one of the first to third aspects, wherein the controller is configured such that, according to one or more attributes of the counterpart kiosk terminal entered by the operator, the controller adjusts the frontal video and the video of the hands to be adapted for the front-facing monitor and the upward-facing monitor of the kiosk terminal, respectively.

In this configuration, it is possible to acquire the frontal video and the video of the hands adapted for the monitors of the kiosk terminal to be a counterpart of communication.

A fifth aspect of the present invention is the operator terminal of the fourth aspect, wherein the controller is configured to display an entry screen on the monitor, the entry screen allowing the operator to enter at least either of a type or specifications of the kiosk terminal as the one or more attributes of the kiosk terminal.

In this configuration, it is possible to acquire the frontal video and the video of the hands adapted for the monitors of the kiosk terminal to be a counterpart of communication.

A sixth aspect of the present invention is the operator terminal of any one of the first to fifth aspects, wherein the controller is configured such that, when the calibration operation is complete, the controller registers settings information in the operator terminal, the settings information being acquired by the calibration operation and associated with the operator, and that, when the operator starts using the operator terminal, the controller identifies the operator who uses the operator terminal and then adjusts the frontal video and the video of the hands based on the settings information associated with the operator.

In this configuration, once a calibration operation is performed when the operator first uses the operator terminal, a subsequent calibration operation can be performed based on the registered settings information, which means that the calibration operation is complete in a short time and the operator becomes able to quickly start providing a response to the user at the operator terminal.

A seventh aspect of the present invention is the operator terminal of any one of the first to sixth aspects, wherein the controller is configured such that, according to a magnification factor entered by the operator, the controller performs a magnification or reduction operation on the frontal video and the video of the hands.

This configuration enables the operator to acquire the videos that are displayed in a state.

An eighth aspect of the present invention is a calibration method used in an operator terminal for bidirectional communication with a kiosk terminal, the operation terminal being configured for bidirectional transmission of a video of a user who operates the kiosk terminal and a video of an operator who operates the operator terminal to and from the kiosk terminal, the calibration method being configured for adjusting the video of the operator who operates the operator terminal displayed on the kiosk terminal, the method comprising: displaying on a monitor a frontal video of an upper body of the operator acquired by a front-facing camera and a video of hands of the operator acquired by a downward-facing camera, wherein the front-facing camera is configured to shoot the frontal video of the upper body of the operator, the frontal video including a face of the operator, and the downward-facing camera is configured to shoot the hands of the operator from above; concurrently with displaying the frontal video and the video of the hands, displaying guidance information on the monitor, the guidance information providing a guidance on a proper state of the operator's upper body in the frontal video and a proper state of the operator's hands in the video of the hands; and, based on inputs which the operator provides according to the guidance information, adjusting the frontal video and the video of the hands.

This configuration allows for efficient calibration operation in the same manner as the first aspect.

Embodiments of the present invention will be described below with reference to the drawings.

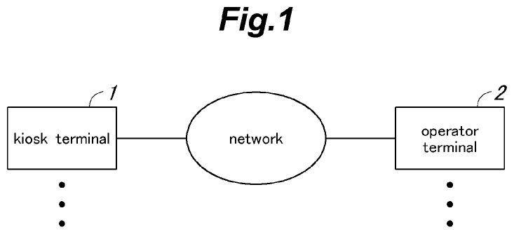

FIG. 1 is a diagram showing a general configuration of a bidirectional video communication system according to an embodiment of the present invention.

The bidirectional video communication system includes a kiosk terminal 1 and an operator terminal 2. The kiosk terminal 1 and the operator terminal 2 are connected to each other via a network such as the Internet, a VPN (Virtual Private Network) or an intranet.

The kiosk terminal 1 is disposed in various facilities and adapted to be operated by a user. The kiosk terminal 1 is configured to transmit a video of the user to the operator terminal 2 and to display a video of an operator received from the operator terminal 2.

The operator terminal 2 is disposed in a facility such as a call center where operators who respond to users are present at all times, and is adapted to be operated by an operator. The operator terminal 2 is configured to transmit a video of an operator to the kiosk terminal 1 and display a video of a user received from the kiosk terminal 1.

The kiosk terminal 1 can provide various services. For example, the kiosk terminal 1 can be disposed in a lobby of a transportation facility such as an airport to thereby provide services such as providing information on nearby sightseeing spots, information on floors in the facility, and information on nearby accommodation facilities. The kiosk terminal 1 can be disposed in a branch of a financial institution such as a bank to thereby provide various services provided at a counter in the branch, such as consulting services associated with opening an account, financial transactions and customer loan. The kiosk terminal 1 is disposed at a reception counter of an accommodation facility such as a hotel to thereby provide various receptionist's services provided by a staff member (concierge). Moreover, the kiosk terminal 1 can be disposed in the entrance lobby of an apartment such as a condominium to thereby provide various services provided by a building janitor.

In this manner, the kiosk terminal 1 can constantly provide various services in place of a person in charge, and thus it becomes possible to improve the quality of services. In addition, since an operator can take charge of a plurality of facilities, it becomes possible to downsize employees.

The kiosk terminal 1 and the operator terminal 2 perform bidirectional communication with each other, transmitting a video of a user and that of an operator to each other. In addition, the kiosk terminal 1 and the operator terminal 2 perform bidirectional communication with each other, transmitting to each other operation information which the user and the operator enter on the kiosk terminal 1 and the operator terminal 2, respectively.

In particular, the terminals can transmit confidential information (for example, personal information such as user's name and address, or a financial institution account number) to each other. For transmission of such confidential information, since a service provider already provides a highly secure network, the terminals may be configured to transmit confidential information other than video via the existing highly secure network while transmitting video via a different network. In this configuration, a necessary security for transmission of confidential information is ensured by using the existing network, whereas video contents, which require a large amount of communication in transmission, can be transmitted over a different network, thereby preventing an increase in the load on the existing network.

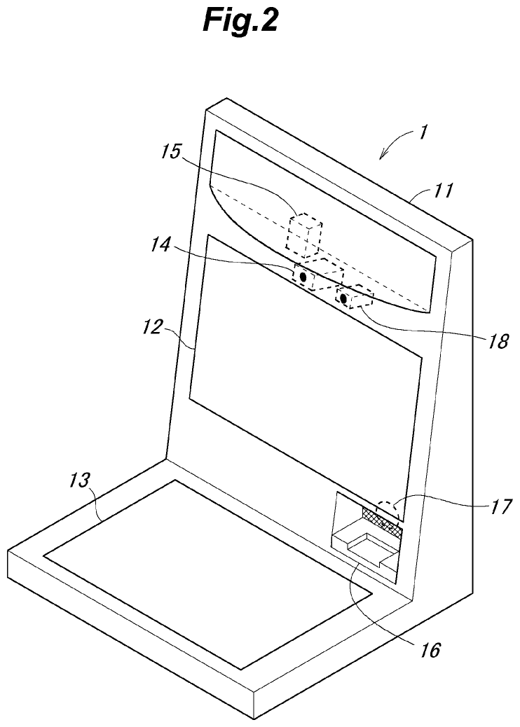

Next, the kiosk terminal 1 will be described. FIG. 2 is a perspective view showing the kiosk terminal 1.

The kiosk terminal 1 includes a housing 11, a front-facing monitor 12, an upward-facing monitor 13, a front-facing camera 14, a downward-facing camera 15, an IC card reader 16, a speaker 17, and a microphone 18.

The front-facing monitor 12 is arranged with its screen facing forward, and the upward-facing monitor 13 is arranged with its screen facing upward. In addition, the upward-facing monitor 13 includes a touchscreen so that users can operate the touchscreen to invoke actions.

The front-facing camera 14 is used to shoot a video of a user's upper body including the user's face from front. The downward-facing camera 15 is used to shoot a video of where the user's hands are placed; that is, shoot a video of the user's hand placed on the upward-facing monitor 13 from above. The user points a finger on the screen of the upward-facing monitor 13, and this situation is shot by the downward-facing camera 15.

The IC card reader 16 reads an IC card carried by the user.

The speaker 17 outputs voice of the operator. The microphone 18 picks up a sound of the user's voice.

The kiosk terminal 1, which is configured this way, is placed on a base such as a counter so that a user can operate the kiosk terminal 1 while sitting on the chair or standing.

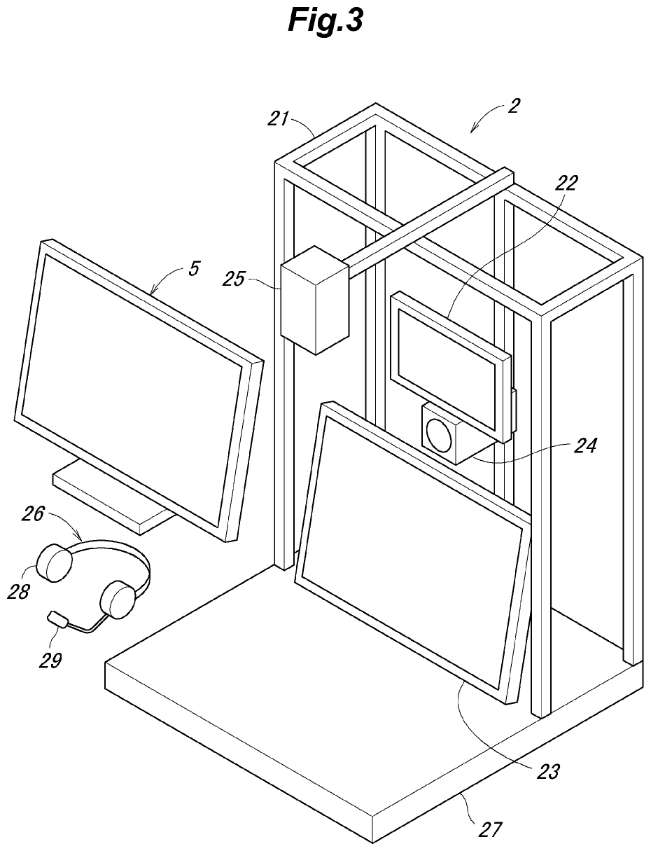

Next, the operator terminal 2 will be described. FIG. 3 is a perspective view showing the operator terminal 2.

The operator terminal 2 includes a frame 21, a first monitor 22, a second monitor 23, a front-facing camera 24, a downward-facing camera 25, a headset 26, and a table 27.

The first monitor 22 is supported by the frame 21 so as to be located at a predetermined height. The second monitor 23 includes a touchscreen so that an operator can operate the touchscreen to invoke actions.

The front-facing camera 24 is used to shoot an operator's upper body including the face from front. The downward-facing camera 25 is used to shoot a video of where the operator's hands can be placed; that is, shoot a video of the operator's hand placed on the table 27 from above. The operator, putting a document such as a brochure on the table, explains the document while pointing a finger on the document, and this situation is shot by the downward-facing camera 25.

The headset 26 includes a speaker 28 and a microphone 29. The speaker 28 outputs voice of the user. The microphone 29 picks up a sound of the operator's voice.

The operator terminal 2 is also provided with a monitor 5. The monitor 5 displays a screen of an application running on the operator terminal 2 or a PC (not shown). The operator terminal 2 shares the screen of the application with the kiosk terminal 1 so that the same screen is displayed on the upward-facing monitor 13 of the kiosk terminal 1 (screen sharing function). The monitor 5 includes a touchscreen, and an operator can draw on the screen by handwriting (whiteboard function).

In a call center, each of the operators uses the operator terminal 2 not only to provide face-to-face response services to a user through video and voice, but also to provide telephone reception services by responding to a user only by voice over the telephone. Thus, the operator terminal 2 is also equipped with a monitor (not shown) for telephone reception services.

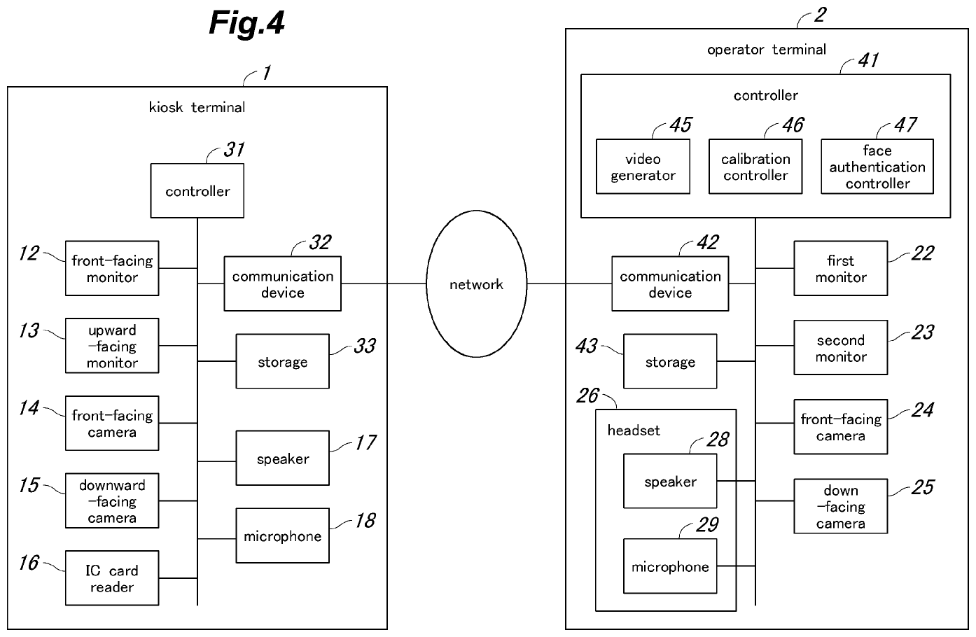

Next, schematic configurations of the kiosk terminal 1 and the operator terminal 2 will be described. FIG. 4 is a block diagram showing schematic configurations of the kiosk terminal 1 and the operator terminal 2.

As described above, the kiosk terminal 1 includes the front-facing monitor 12, the upward-facing monitor 13, the front-facing camera 14, the downward-facing camera 15, the IC card reader 16, the speaker 17, and the microphone 18. The kiosk terminal 1 also includes a controller 31, a communication device 32, and a storage 33.

The communication device 32 performs communication with the operator terminal 2 via a network.

The storage 33 stores programs executable by a processor, which implements the controller 31.

The controller 31 is configured by the processor, which executes a program stored in the storage 33 to thereby execute a predetermined process. In the present embodiment, the controller 31 performs connection control operations to make a connection to the operator terminal 2, and also performs video transmission control for real-time transmission/reception of videos of the user and the operator shot by the kiosk terminal 1 and the operator terminal 2, respectively.

As described above, the operator terminal 2 includes the first monitor 22, the second monitor 23, the front-facing camera 24, the downward-facing camera 25, and the headset 26. The operator terminal 2 also includes a controller 41, a communication device 42, and a storage 43.

The communication device 42 performs communication with the kiosk terminal 1 via the network.

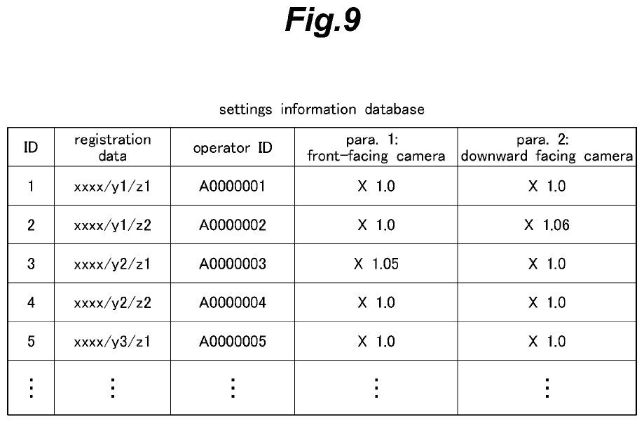

The storage 43 stores programs executable by a processor, which implements the controller 41. The storage 43 also stores records registered in a settings information database, the records being associated with settings information regarding calibration for each operator (see FIG. 9). In addition, the storage 43 stores records registered in an operator database, the record being associated with feature information including features of each operator's face to be used in face authentication on the operator.

The controller 41 includes a video generator 45, a calibration controller 46, and a face authentication controller 47. The controller 41 is configured by a processor, and each unit of the controller 41 is implemented by executing a program stored in the storage 43 by the processor.

The video generator 45, based on settings information set by the calibration controller 46 and attributes (type and specifications) of the kiosk terminal 1 which is a communication counterpart, generates a frontal video of the operator, the frontal video being adapted for the front-facing monitor 12 of the counterpart kiosk terminal 1, from a frontal video of the operator shot by the front-facing camera 24, and also generates a video of hands of the operator, the video being adapted for the upward-facing monitor 13 of the counterpart kiosk terminal 1, from a video of the hands of the operator shot by the downward-facing camera 25. The video generator 45 performs a prescribed processing operation (such as extraction of a cutout) on the frontal video of the operator and the video of the operator's hands.

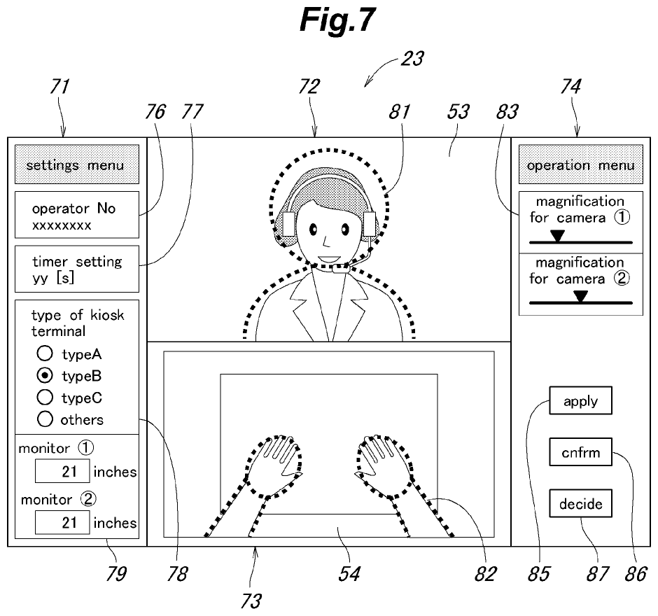

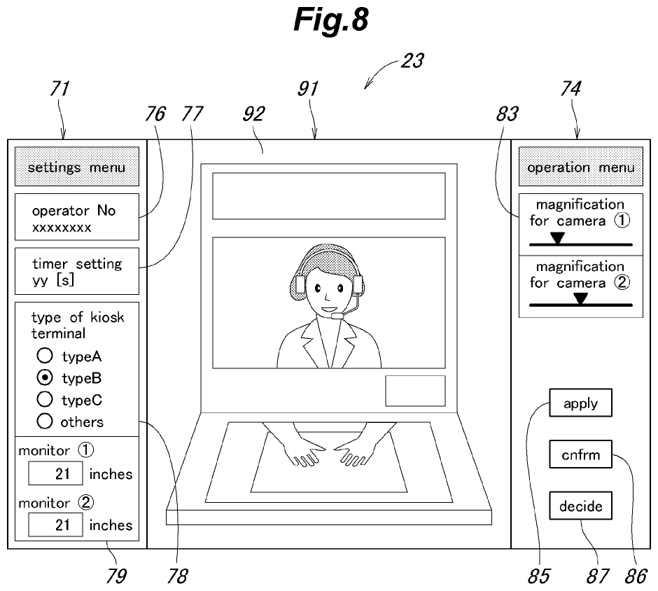

The calibration controller 46 displays a screen for calibration operation (see FIGS. 7 and 8) on the second monitor 23, sets parameters for calibration in response to the operator's operation on the screen, and registers the parameters in the settings information database as settings information. In the present embodiment, the calibration controller 46 sets magnification factors for the front-facing camera 24 and the downward-facing camera 25 as the parameters for calibration.

Also, the calibration controller 46 urges the operator to perform a selection operation for selecting the type of the counterpart kiosk terminal on the screen for calibration operation, and acquires the type of the counterpart kiosk terminal. In addition, the calibration controller 46 urges the operator to perform an entry operation for entering the specifications of the counterpart kiosk terminal on the screen for calibration operation, and acquires the specifications of the counterpart kiosk terminal.

Moreover, the calibration controller 46 acquires the operator ID of the operator who operates the operator terminal 2, and acquires corresponding settings information for the operator from the settings information database and performs an operation to reflect the settings information in a screen for calibration operation.

Additionally, in the calibration operation, it is necessary to adjust the magnification factors, and further necessary to adjust the height of a chair on which operator sits in order to display the frontal video of the operation such that the eye heights of the user and the operator are at the same level.

The face authentication controller 47 verifies whether the operator operating the operator terminal 2 is a person registered in the operator database when starting the calibration operation. Specifically, the face authentication controller 47 detects a person's face in the frontal video of the operator shot by the front-facing camera 24, extracts feature information including features of the detected person's face, and compares the feature information with feature information for each operator's face registered in the operator database for matching. If the detected face is authenticated through the face authentication, the face authentication controller 47 acquires a corresponding operator ID from the operator database. The face authentication controller 47 may be configured such that whether or not to enable the face authentication function can be preset.

In the present embodiment, the face authentication controller 47 performs face authentication on the operator who uses the operator terminal 2, thereby enabling the face authentication controller 47 to acquire the operator ID of the operator who uses the operator terminal 2. However, in other embodiments, the face authentication controller 47 may be configured to urge an operator to enter the operator ID or cause the IC card reader to read an IC card carried by the operator, thereby enabling the face authentication controller 47 to acquire the operator ID.

Furthermore, the controller 41 performs connection control to make a connection to the kiosk terminal 1, and also performs video transmission control for real-time transmission/reception of videos of the user and the operator which are shot by the kiosk terminal 1 and the operator terminal 2, respectively.

It should be noted that the operator terminal 2 may be provided with a scanner used for scanning a document(s) an operator has. In addition, the operator terminal 2 may be provided with an IC card reader used to authenticate an operator who operates the terminal as an authorized operator. Moreover, the kiosk terminal 1 may be provided with a printer used to print out a document transmitted from the operator terminal 2 or information displayed on the screen.

The second monitor 23 may be configured by a tablet PC; that is, configured such that the controller 41, the communication device 42, and the storage 43 are accommodated in a housing of the second monitor 23.

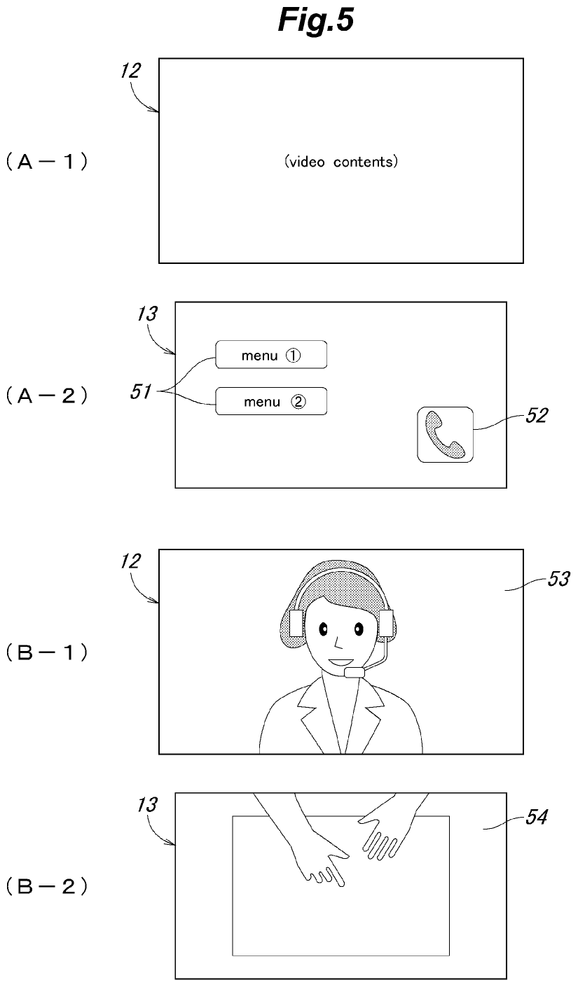

Next, screens displayed on the kiosk terminal 1 will be described. FIG. 5 is an explanatory diagram showing the screens displayed on the kiosk terminal 1.

In the kiosk terminal 1, the front-facing monitor 12 operates as digital signage during standby (before connecting to the operator terminal 2), and as shown in FIG. 5(A-1), the kiosk terminal 1 displays on the front-facing monitor 12 video contents relating to advertisements such as recommended plans and guide maps of facilities.

Also, during standby, as shown in FIG. 5(A-2), a menu screen (operation screen) is displayed on the upward-facing monitor 13. The menu screen includes displayed operation buttons 51 corresponding to various menu items. The menu screen also includes a call button 52. When the user operates the call button 52, the kiosk terminal 1 makes a connection to the operator terminal 2 so that the kiosk terminal 1 can start interaction with the operator. The controller 31 may be configured such that, when a sensor such as a human sensor detects the user in front of the kiosk terminal 1, the controller 31 automatically launches the menu screen, and when the kiosk terminal 1 is continuously in a non-use state for a predetermined period of time, the controller 31 shifts the screen from the menu screen to a screen in non-displayed state.

When the front-facing monitor 12 operates as digital signage, the kiosk terminal 1 may read data of video contents pre-stored in the storage 33 in order to reproduce the video contents. In this case, the kiosk terminal 1 may be configured such that a memory card storing video contents data is be attached to the kiosk terminal 1, or the video contents data is distributed from a distribution server to the kiosk terminal 1 via the network.

When the kiosk terminal 1 is connected to the operator terminal 2, the front-facing monitor 12 displays a frontal video 53 of the operator shot by the front-facing camera 24 of the operator terminal 2 as shown in FIG. 5(B-1), and simultaneously, the upward-facing monitor 13 displays a video 54 of the operator's hand shot by downward-facing camera 25 of the operator terminal 2 as shown in FIG. 5(B-2).

The front-facing monitor 12 displays the frontal video 53 of the operator so that the height of the eyes of the user matches that of the operator, whereas the upward-facing monitor 13 displays a video 54 of the operator's hands so that the height of the user matches that of the operator. As a result, the user can experience a realistic sensation that the user faces the operator over the counter.

The video 54 of the operator's hands displayed on the upward-facing monitor 13 shows a situation in which the operator makes an explanation, pointing a finger on a document such as a brochure, so that the user and the operator can interact with each other while pointing their fingers on the document.

The operator can perform an operation on the operator terminal so that the upward-facing monitor 13 of the kiosk terminal 1 displays a screen of an application. The kiosk terminal 1 shares the screen of the application with the operator terminal 2 so that the same screen is displayed on the operator terminal 2 (screen sharing function). Also, the user can draw on the screen of the application by handwriting (whiteboard function).

The kiosk terminal 1 may be configured such that the front-facing monitor 12 displays a frontal video of the operator with the operator's background masked.

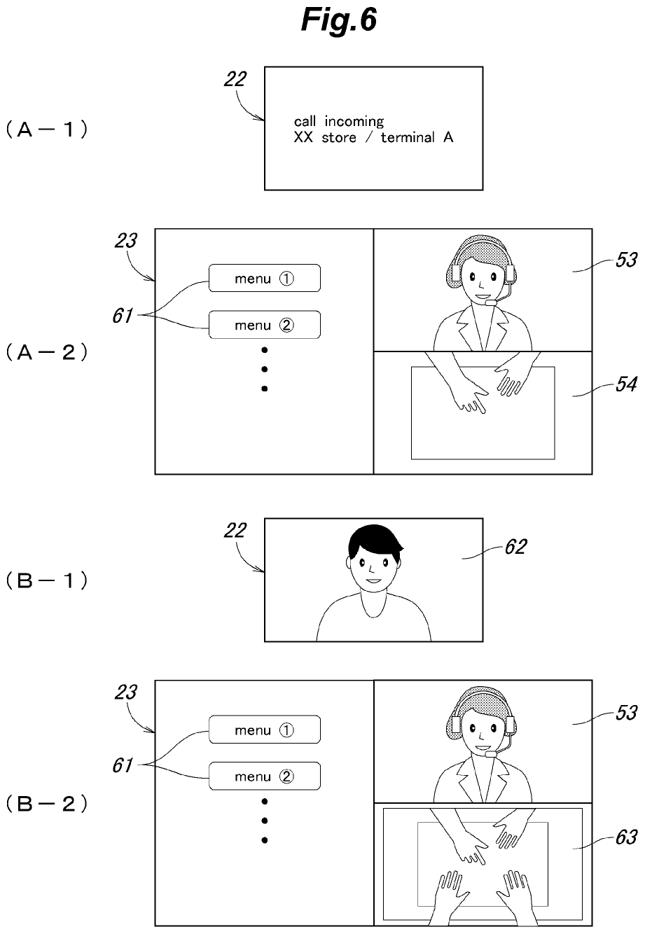

Next, screens displayed on the operator terminal 2 will be described. FIG. 6 is an explanatory diagram showing the screens displayed on the operator terminal 2.

During standby, the first monitor 22 of the operator terminal 2 displays a standby screen, and when the user operates the call button 52 (see FIG. 5(A-2)), a call incoming screen as shown in FIG. 6(A-1) is displayed on the first monitor 22. The call incoming screen shows information on the counterpart kiosk terminal 1 (such as disposed location or terminal name).

During standby, an operation screen as shown in FIG. 6(A-2) is displayed on the second monitor 23 of the operator terminal 2. The operation screen shows operation buttons 61 corresponding to various menu items such as those used to control the operator terminal 2 and give instructions to the kiosk terminal 1.

The second monitor 23 displays the frontal video 53 of the operator shot by the front-facing camera 24 of the operator terminal 2 and the video 54 of the operator's hands shot by downward-facing camera 25 of the operator terminal 2, which are both same as those displayed on the kiosk terminal 1. The video 54 of the operator's hands can be switched between the video displayed in the original form and that in a vertically flipped form.

When the operator terminal 2 is connected to the kiosk terminal 1, the first monitor 22 displays a frontal video 62 of the user shot by the front-facing camera 14 of the kiosk terminal 1 as shown in FIG. 6(B-1). The first monitor 22 is supported by the frame 21 so as to be located at a predetermined height (see FIG. 3), which allows the height of the operator'eyes to match that of the user's eyes.

As shown in FIG. 6B-2, the second monitor 23 displays the operation buttons 61 in the same manner as during standby. The second monitor 23 also displays the frontal video 53 of the operator in the same manner as during standby. The screen displayed on the second monitor can be switched between the frontal video 53 of the operator and the video of the operator's hands. The second monitor 23 displays a video 63 of the user's hands shot by the downward-facing camera 15 of the kiosk terminal 1 concurrently with displaying the video of the operator's hands. The video 63 of the user's hands can be switched between the video displayed in the original form and that in a vertically flipped form.

The video 63 of the user's hands displayed on the second monitor 23 shows a situation in which the user points a finger on a document such as a brochure on the upward-facing monitor 13 of the kiosk terminal 1, so that the user and the operator can interact with each other while pointing their fingers on the document.

In the present embodiment, the operator terminal 2 is configured such that the first monitor 22 displays the frontal video 62 of the user, and the second monitor 23 displays the video 63 of the user's hands. However, the operator terminal 2 may be configured such that a single monitor displays the user's frontal video 62 and the video 63 of the user's hands. In this case, the operator can experience a realistic sensation that the operator faces the user over the counter.

Next, screens displayed on the operator terminal 2 during a calibration operation will be described. FIG. 7 is an explanatory diagram showing a screen for calibration operation in an initial state. FIG. 8 is an explanatory diagram showing a screen for calibration operation in a confirmation state.

As shown in FIG. 7, when the calibration operation is performed, first, the second monitor 23 of the operator terminal 2 displays a screen for a calibration operation in the initial state. The screen in the initial state includes a settings menu indicator 71, a frontal video indicator 72, a video-of-hands indicator 73, and an operation menu indicator 74.

The settings menu indicator 71 includes an operator ID indicator 76, a timer setting value indicator 77, a terminal type selector 78, and a terminal specifications input 79.

The operator ID indicator 76 indicates an operator ID. The timer setting value indicator 77 indicates a timer setting value.

The terminal type selector 78 is used by an operator such that the operator operates radio buttons therein to select the type (specification) of the kiosk terminal 1. Different types of kiosk terminals 1 can have a front-facing monitor 12 and a upward-facing monitor 13 of different sizes, and the monitors can be used as a horizontal monitor (providing a screen having a longer width than height) or a vertical monitor (providing a screen having a longer height than width).

The terminal specifications input 79 enables an operator to enter specifications of the counterpart kiosk terminal; that is, the sizes of the front-facing monitor 12 and the upward-facing monitor 13 of the kiosk terminal 1. This enables the operator terminal to perform a calibration operation in a proper manner even when the type of the kiosk terminal 1 is different from any of the options selectable at the terminal type selector 78. The terminal specifications input 79 may be configured to enable an operator to enter the interval (monitor interval) between the front-facing monitor 12 and the upward-facing monitor 13. Furthermore, the terminal specifications input 79 may be configured to enable an operator to set, in addition to the sizes of the monitors, the aspect ratios of the monitors' screens.

The frontal video indicator 72 displays the frontal video 53 of the operator shot by the front-facing camera 24 of the operator terminal 2. In addition, the frontal video indicator 72 displays a guidance video image 81 representing a contour of the upper body of a person, that is, a fl shape formed by the head and shoulders of the person. The operator performs a calibration operation for calibrating the operator's frontal video 53 based on the guidance video image 81.

The video-of-hands indicator 73 displays a video 54 of hands of the operator shot by the downward-facing camera 25 of the operator terminal 2. In addition, the video-of-hands indicator 73 displays a guidance video image 82 representing a contour of person's hands. The operator performs a calibration operation for calibrating the video of the operator's hands based on the guidance video image 82. The video of the operator's hands displayed on the video-of-hands indicator 73 may be switched between the video displayed in the original form and that in a vertically flipped form.

The operation menu indicator 74 includes a magnification factor input 83. The magnification factor input 83 includes sliders of slide bars which an operator can operate to input a magnification factor of the front-facing camera 24 and the downward-facing camera 25. The operator adjusts the magnification factor of the front-facing camera 24 so that the operator's face shown in the frontal video 53 displayed on the frontal video indicator 72 approximately conforms to the guidance video image 81. Also, the operator adjusts the magnification factor of the downward-facing camera 25 so that the operator's hands shown in the video 54 of the operator's hands displayed on the video-of-hands indicator 73 approximately conform to the guidance video image 82.

The height of the operator's face in the frontal video 53 displayed on the frontal video indicator 72 may be adjusted by raising and lowering the height of a chair on which operator sits.

In this step, when the operator performs an operation of changing the magnification factor of the front-facing camera 24, the frontal video 53 displayed on the frontal video indicator 72 is magnified or reduced so that the size of the operator's face shown in the frontal video 53 can be adjusted. Moreover, when the operator performs an operation of changing the magnification factor of the downward-facing camera 25, the video 54 of the operator's hands displayed on the video-of-hands indicator 73 is magnified or reduced so that the size of the operator's hands shown in video 54 of the hands can be adjusted.

Preferably, the operator first adjusts the position and size of the operator's hands according to the guidance video image 82 displayed on the video-of-hands indicator 73, and then adjusts the height and size of the operator's face according to the guidance video image 81 displayed on the frontal video indicator 72 so as to be appropriate for the position and size of the hands in the video of the hands. In other embodiments, the operator may first adjust the position and size of the operator's face and then adjust the position and size of the operator's hands. Alternatively, the operator may perform the adjustments of the position and size of the operator's face and those of the operator's hands in an alternate manner.

The operation menu indicator 74 includes an apply button 85, a confirm button 86, and a decide button 87.

I operation, after selecting the type of the kiosk terminal 1 at the terminal type selector 78, the operator can enter the sizes of the front-facing monitor 12 and the upward-facing monitor 13 of the kiosk terminal 1 at the terminal specifications input 79 and then operates the apply button 85, which results in that the guidance video images 81 and 82 adapted for the type and the monitor size of the kiosk terminal 1 are displayed on the frontal video indicator 72 and the video-of-hands indicator 73, respectively.

When the operator operates the confirm button 86, the screen transitions to a screen for calibration operation (see FIG. 8).

When the operator operates the decide button 87, the settings information is updated with entries in the screen for calibration operation.

As shown in FIG. 8, the screen for calibration operation screen in the confirmation state includes a kiosk terminal indicator 91. In the screen, the settings menu indicator 71 and the operation menu indicator 74 are the same as those in the screen in the initial state (see FIG. 7).

The kiosk terminal indicator 91 displays virtual video images 92 indicating how the frontal video of the operator and the video of the operator' hands are displayed on the kiosk terminal 1. The kiosk terminal 1 shown in the virtual video image 92 reflects the type of the kiosk terminal 1 selected at the terminal type selector 78 and the sizes of the front-facing monitor 12 and the upward-facing monitor 13 entered at the terminal specifications input 79. The frontal video of the operator and the video of the operator's hands displayed on the front-facing monitor 12 and the upward-facing monitor 13 in the virtual video image 92 reflect the magnification factors entered at the magnification factor input 83.

As described above, in the present embodiment, since the operator terminal displays the virtual video images 92 according to the attributes (type or specifications) of the counterpart kiosk terminal 1, the operator can properly determine whether or not the operator is displayed in the kiosk terminal 1 in an appropriate manner. In particular, what is important is that the operator's face (upper body) and the operator's hands are displayed on the front-facing monitor 12 and the upward-facing monitor 13, respectively, in such a proper balance that the face and the hands are recognizable as parts of one operator's body, and the virtual video images 92 enable the operator to quickly confirm that the face and the hands are displayed on the kiosk terminal in such a proper manner as to be recognizable as parts of one operator's body.

Next, a settings information database managed by the operator terminal 2 will be described. FIG. 9 is an explanatory diagram showing records registered in the settings information database.

The operator terminal 2 manages calibration settings information for each operator registered in the settings information database. Registered in the settings information database are a set of records for each event in which settings information is recorded, the set of records including a record ID, registration date, an operator ID, a first parameter for the front-facing camera 24, and a second parameter for the downward-facing camera 25. The first parameter is a magnification factor for the front-facing camera 24 and the second parameter is a magnification factor for the downward-facing camera 25.

Each time an operator performs a calibration operation, the settings information for the operator is registered in the settings information database. When the operator uses the operator terminal 2 subsequently, the operator terminal acquires the settings information (parameters) for the operator from the settings information database, and displays a screen for calibration operations (see FIGS. 7 and 8) reflecting the settings information, and thus some operations to be performed by the operator are omitted.

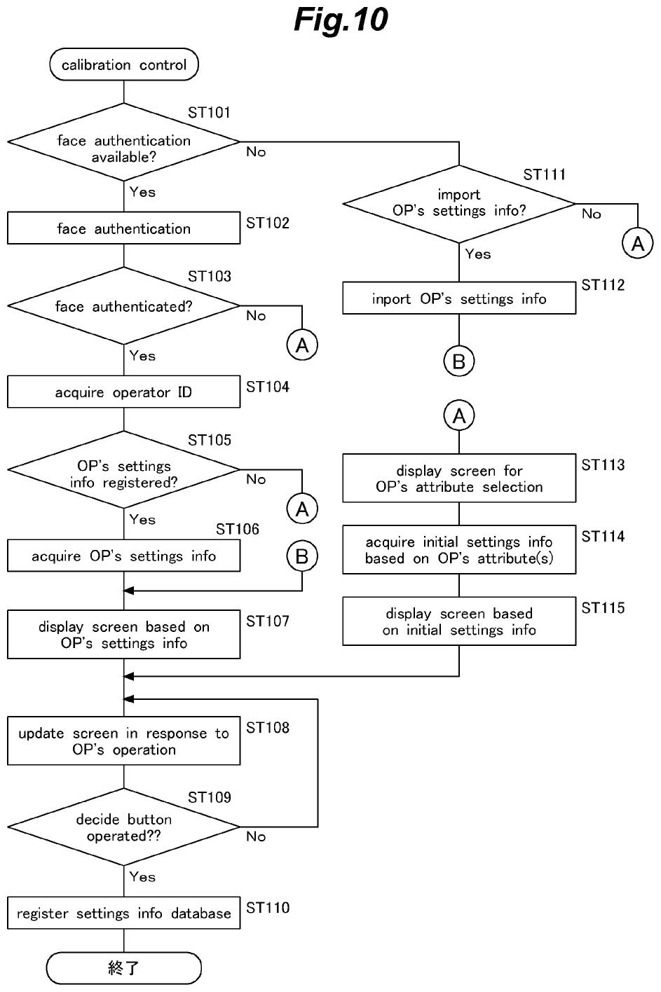

Next, a calibration control operation performed by the operator terminal 2 will be described. FIG. 10 is a flow chart showing an operation procedure of the calibration control operation.

The operator terminal 2 first determines whether or not face authentication is valid or available (ST101). If the face authentication is available (Yes in ST101), the operator terminal 2 performs face authentication on the operator who is operating the operator terminal 2 based on the frontal video of the operator shot by the front-facing camera 24 (ST102). Then, the operator terminal 2 determines whether or not the operator's face is authenticated through face authentication (ST103).

If the operator's face is authenticated through face authentication (Yes in ST103), the operator terminal 2 acquires the operator ID from the operator database (ST104). Then, the operator terminal 2 determines, based on the acquired operator ID, whether or not the operator who is operating the operator terminal 2 is registered in the settings information database (ST105).

If the operator is registered in the settings information database (Yes in ST105), the operator terminal 2 acquires the settings information for the operator from the settings information database (ST106). Then, the operator terminal 2 displays a screen for calibration operation (see FIGS. 7 and 8) reflecting the settings information for the operator (ST107).

Next, if the operator performs an operation on the screen for calibration operation, the operator terminal 2 updates the screen for calibration operation according to the operation (ST108). Then, if the operator operates the decide button (Yes in ST109), the operator terminal 2 registers entries entered by the operator on the screen for calibration operation in the settings information database as the setting information for the operator (ST110).

If the face authentication is not available (No in ST101), the operator terminal 2 then determines whether or not to import the settings information for the operator (ST111). If the operator terminal 2 imports the settings information for the operator (Yes in ST111), the operator terminal 2 urges the operator to enter the operator ID, and imports the operator settings information based on the operator ID (ST112). Then, the process proceeds to ST107, and the operator terminal 2 displays the screen for calibration operation reflecting the imported settings information for the operator.

If the operator's face is not authenticated (No in ST103), if the operator is not registered in the settings information database (No in ST105), or if the settings information of the operator is not imported (No in ST111), the operator terminal 2 displays a screen for selecting the operator's attribute(s) (ST113). Then, if the operator performs an operation to select the attribute(s) of the operator, the operator terminal 2 acquires initial settings information according to the attribute(s) selected by the operator (ST114). Next, the operator terminal 2 displays a screen for calibration operation reflecting the initial settings information (ST115).

Then, the process proceeds to ST108.

The operator's attributes are attributes relating to gender (male, female) and a physique (large, standard, small). Thus, depending on these attributes, the size of the operator's body differs, which leads to a change in the states of the frontal video of the operator and the video of the operator's hands displayed on the kiosk terminal 1. As such, the operator terminal 2 acquires initial setting information according to the attributes of the operator. For example, when the operator is a large male person, the operator appears to be large, and the operator terminal 2 sets a relatively low magnification factor as the initial settings information.

As described above, in the present embodiment, in the case of the operator's first use of the operator terminal 2, the operator terminal 2 performs a calibration operation based on the initial settings information (preset information) according to the attributes of the operator, which allows for efficient calibration operation.

If the operator has used the operator terminal 2 before, the operator terminal 2 identifies the operator by face authentication and automatically performs a calibration operation based on the operator settings information, which means that the operator only needs to adjust the height of a chair. As a result, the calibration operation can be complete in a short time, and the operator can quickly start providing face-to-face response services using the operator terminal 2. In addition, the adjustment of the height of the operator sitting in front of the operator terminal may be achieved not only by raising and lowering the height of a chair, but also by using a table provided with an electric lifting mechanism. In this connection, the operator terminal 2 may be configured to also register the information record of the height of the operator sitting at the operator terminal as part of the operator's settings information.

While specific embodiments of the present invention are described herein for illustrative purposes, the present invention is not limited to the specific embodiments. It will be understood that various changes, substitutions, additions, and omissions may be made for elements of the embodiments without departing from the scope of the invention. In addition, elements and features of the different embodiments may be combined with each other as appropriate to yield an embodiment which is within the scope of the present invention.

### INDUSTRIAL APPLICABILITY

An operator terminal and a calibration method used therein according to the present invention achieve an effect of, upon a change in operators, supporting a new operator's work associated with a calibration operation for calibrating video images so as to show a new operator in a proper state in a video displayed on a kiosk terminal, thereby allowing efficient calibration operation, and are useful as an operator terminal for bidirectional communication with a kiosk terminal, the operator terminal being configured for bidirectional transmission of a video of a user who operates the kiosk terminal and a video of an operator who operates the operator terminal to and from the kiosk terminal, and a calibration method used in an operator terminal for adjusting a video of an operator to be displayed on a kiosk terminal.

### Glossary

1 kiosk terminal
2 operator terminal
12 front-facing monitor
13 upward-facing monitor
14 front-facing camera
15 downward-facing camera
22 first monitor
23 second monitor
24 front-facing camera
25 downward-facing camera
31 controller
32 communication device
33 storage
41 controller
42 communication device
43 storage
53 operator's frontal video
54 video of operator's hands
79 terminal type selector
79 terminal specifications input
81, 82 guidance video image
83 magnification factor input
92 virtual video image

1. An operator terminal for bidirectional communication with a kiosk terminal, the operator terminal being configured for bidirectional transmission of a video of a user who operates the kiosk terminal and a video of an operator who operates the operator terminal to and from the kiosk terminal, the operator terminal comprising:
a communication device configured to perform communication with the kiosk terminal;
a front-facing camera configured to shoot a frontal video of an upper body of the operator, the frontal video including a face of the operator;
a downward-facing camera configured to shoot hands of the operator from above;
a controller configured to transmit the frontal video shot by the front-facing camera and the video of the hands shot by the downward-facing camera to the kiosk terminal, causing the kiosk terminal to display the videos on a front-facing monitor and an upward-facing monitor; and
a monitor configured to display a status of a calibration operation for adjusting the frontal video and the video of the hands,
wherein the controller is configured such that the controller displays guidance information on the monitor, the guidance information providing a guidance on a proper state of the operator's upper body in the frontal video and a proper state of the operator's hands in the video of the hands, and that, based on inputs which the operator provides according to the guidance information, the controller adjusts the frontal video and the video of the hands.

2. The operator terminal according to claim 1, wherein the controller is configured such that the controller displays, as the guidance information, a guidance image indicating the proper state of the operator's upper body in the frontal video and a guidance image indicating the proper state of the operator's upper body in the frontal video.

3. The operator terminal according to claim 1, wherein the controller is configured to display virtual video images on the monitor, the virtual video images indicating how the frontal video and the video of the hands are displayed on the kiosk terminal, respectively.

4. The operator terminal according to claim 1, wherein the controller is configured such that, according to one or more attributes of the counterpart kiosk terminal entered by the operator, the controller adjusts the frontal video and the video of the hands to be adapted for the front-facing monitor and the upward-facing monitor of the kiosk terminal, respectively.

5. The operator terminal according to claim 4, wherein the controller is configured to display an entry screen on the monitor, the entry screen allowing the operator to enter at least either of a type or specifications of the kiosk terminal as the one or more attributes of the kiosk terminal.

6. The operator terminal according to claim 1, wherein the controller is configured such that, when the calibration operation is complete, the controller registers settings information in the operator terminal, the settings information being acquired by the calibration operation and associated with the operator, and that, when the operator starts using the operator terminal, the controller identifies the operator who uses the operator terminal and then adjusts the frontal video and the video of the hands based on the settings information associated with the operator.

7. The operator terminal according to claim 1, wherein the controller is configured such that, according to a magnification factor entered by the operator, the controller performs a magnification or reduction operation on the frontal video and the video of the hands.

8. A calibration method used in an operator terminal for bidirectional communication with a kiosk terminal, the operation terminal being configured for bidirectional transmission of a video of a user who operates the kiosk terminal and a video of an operator who operates the operator terminal to and from the kiosk terminal, the calibration method being configured for adjusting the video of the operator who operates the operator terminal displayed on the kiosk terminal, the method comprising:
displaying on a monitor a frontal video of an upper body of the operator acquired by a front-facing camera and a video of hands of the operator acquired by a downward-facing camera, wherein the front-facing camera is configured to shoot the frontal video of the upper body of the operator, the frontal video including a face of the operator, and the downward-facing camera is configured to shoot the hands of the operator from above;
concurrently with displaying the frontal video and the video of the hands, displaying guidance information on the monitor, the guidance information providing a guidance on a proper state of the operator's upper body in the frontal video and a proper state of the operator's hands in the video of the hands; and
based on inputs which the operator provides according to the guidance information, adjusting the frontal video and the video of the hands.
